(19) United States
(12) Patent Application Publication
(10) Pub. No.: US 2026/0048951 A1
(43) Pub. Date: Feb. 19, 2026

(54) CONVEYING LINE FOR PNEUMATIC CONVEYANCE OF MATERIALS, USE, AND PNEUMATIC CONVEYANCE SYSTEM

(71) Applicant: DYNAMIC AIR LTDA, Sao Paulo (BR)

(72) Inventors: Horacio N. Paez, Sao Paulo (BR); Gregory J. Steele, Saint Paul, MN (US)

(73) Assignee: DYNAMIC AIR LTDA, Sao Paulo (BR)

(21) Appl. No.: 19/264,282

(22) Filed: Jul. 9, 2025

(30) Foreign Application Priority Data
Aug. 13, 2024 (BR) 1020240165420

(51) Int. Cl. B65G 53/58; B65G 53/54

(52) U.S. Cl. CPC B65G 53/58; B65G 53/54

(57) ABSTRACT

The present invention relates to a conveying line for the pneumatic conveyance of materials, comprising: at least one flexible part; at least one rigid part; and at least one gas injecting device installed in at least one of the rigid parts, wherein the at least one flexible part and the at least one rigid part are intercalatedly connected.

### TECHNICAL FIELD

The present invention is related to the pneumatic conveyance of materials. In particular, the present invention is related to a conveying line to be used in the pneumatic conveyance of materials.

### PRIOR ART

The technology of pneumatic conveyance of materials is widely known in the prior the art. It is based on the use of a flow of air or other gas to move material from one location to another. Pneumatic conveyance is widely used in several industries, such as food, pharmaceutical and chemical industries, for being an efficient, safe and clean form of transportation. Pneumatic conveyance generally involves a system composed of one or more pipes, valves, air pumps or compressors, tanks and pneumatic conveyors. Usually, the materials to be transported are loaded inside a pneumatic conveyor that is typically responsible for pushing the material from its interior into a conveying line by means of a gas stream. Depending on the application, pneumatic conveyance can be carried out in two main ways: diluted or dense phase.

The use of gas injecting devices along a conveying line that connects a pneumatic conveyor to the destination of the material to be transported is also known in the prior art, the destination being, for example, a tank, a silo or even another pneumatic conveyor. Such injecting devices typically operate by means of a pressure difference. When a pressure in the conveying line is below a pressure of a gas supply head of the injecting device, the gas flows through the injecting device into the line. When a pressure in the conveying line is above a pressure of the gas supply head of the injecting device, a valve, such as a diaphragm, closes the gas flow from the injecting device. The use of gas injectors along the conveying line in a pneumatic conveying system helps in moving materials and reduces the amount of gas to be inserted into a pneumatic conveyor.

However, the installation of gas injecting devices in a conveying line must be done carefully, in order to avoid both the gas from escaping from the injecting device to the external environment and the gas from escaping from the conveying line to the external environment or into the injecting device. For these and other reasons, it is common to use rigid and metallic pipes as conveying lines. On the other hand, the use of metallic pipes makes the design and installation of pneumatic conveying systems between hard-to-reach locations more complex.

### SUMMARY OF THE INVENTION

The present invention relates to a conveying line for the pneumatic conveyance of materials, comprising: at least one flexible part; at least one rigid part; and at least one gas injecting device installed in at least one of the rigid parts, wherein the at least one flexible part and the at least one rigid part are intercalatedly connected.

Optionally, the gas injected by the gas injecting device is air.

Optionally, the conveying line additionally comprises at least one cover positioned around at least one gas injecting device.

Optionally, the conveying line additionally comprises at least one elevating element positioned around one end of a flexible part.

Optionally, the elevating element is a cylindrical element.

Optionally, the elevating element is positioned at the ends of each flexible part close to the connection with each rigid part.

The present invention also relates to the use of the conveying line as defined above in the pneumatic conveyance of materials.

The present invention also relates to a pneumatic conveyance system, which comprises at least one pneumatic conveyor and a conveying line as defined above.

### BRIEF DESCRIPTION OF THE DRAWINGS

FIG. 1 illustrates an example of pneumatic conveyance as known in the prior art.

FIG. 2 illustrates a conveying line according to an embodiment of the present invention.

FIG. 3 illustrates the installation of a gas injecting device known in the prior art in the conveying line according to an embodiment of the present invention.

FIG. 4 illustrates in greater detail a part of a conveying line according to an embodiment of the present invention.

### DETAILED DESCRIPTION

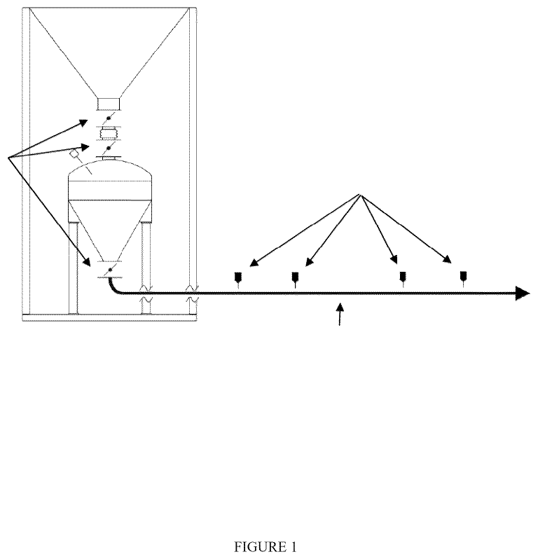

FIG. 1 illustrates part of a pneumatic conveyance process as known in the prior art. Typically, material to be conveyed is dumped into a hopper 10. The material subsequently flows into a pneumatic conveyor 20. Valves 30 control the closing and opening of the passage between the hopper 10 and the pneumatic conveyor 20, and the outlet of the pneumatic conveyor 20. With the pneumatic conveyor 20 loaded with material, gas is injected to pressurize the pneumatic conveyor 20 and force the material out into a conveying line 40. Gas injecting devices 50 are positioned along the conveying line 40 to assist in moving the material in the line 40 toward a silo, for example (not illustrated).

To ensure that the material flows smoothly along the conveying line 40, the conveying line typically consists of a rigid metal pipe. The installation of a metal pipeline does not present major challenges in large spaces without major obstacles. However, it can be challenging in routes located in tight environments, on multiple levels and/or with difficult access. Furthermore, the installation of metal pipelines is particularly challenging in aquatic environments, where the conveying line, or at least part of it, must be installed over water. An example of such environments is an offshore oil platform, both the internal environment of the platform and possible routes between the platform and vessels outside the platform.

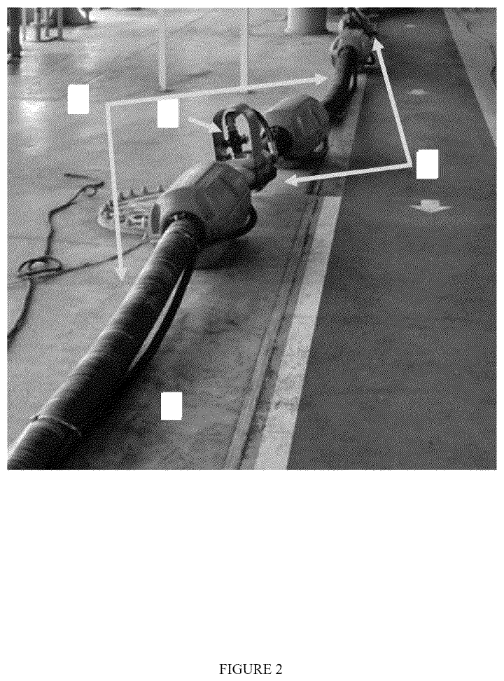

FIG. 2 illustrates a conveying line 40 according to an embodiment of the present invention. The line comprises at least one flexible part 41 and at least one rigid part 42, which are interchangeable. The conveying line 40 also comprises at least one gas injecting device 50, installed in at least one of the rigid parts 42.

As previously mentioned, the installation of gas injecting devices in a conveying line must be done carefully, so as to avoid both gas from escaping the injecting device to the external environment and gas from escaping the conveying line to the external environment or into the injecting device. For these reasons, the installation of a gas injecting device 50 in a flexible conveying line is problematic. The division of a conveying line 40 into flexible parts 41 and rigid parts 42 gives the design of a pneumatic conveying system more flexibility in choosing the path to be taken by the material to be transported. At the same time, it ensures a precise and more reliable installation of the gas injecting devices 50.

Preferably, the gas to be used in pneumatic conveyance is air.

Preferably, the flexible part 41 of the conveying line 40 according to the present invention is a part of rubber hose. As can be noted, any other flexible material can be used.

Preferably, the rigid part 42 of the conveying line 40 according to the present invention is a part of rigid metal pipeline.

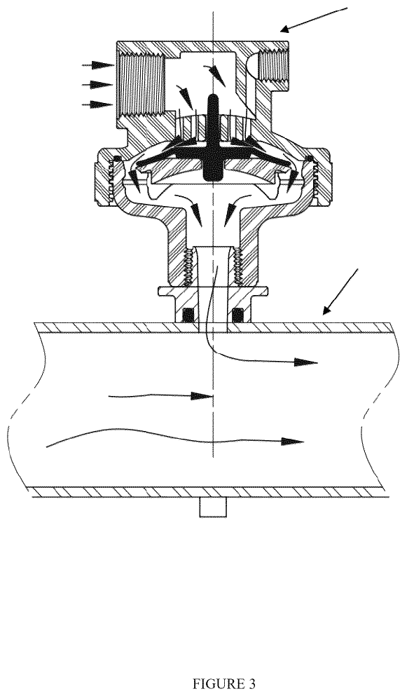

Gas injecting devices 50 as known in the prior art can be used for the purposes of the present invention. As an example, the DC-5 Air Saver® device manufactured and commercialized by Dynamic Air is cited. FIG. 3 illustrates the installation of a DC-5 device 50 in a rigid part 42.

The connection between a flexible part 41 and a rigid part 42 of the conveying line 40 can be made by applying techniques known in the prior art. One possible example is the installation of a metal tip at one end of the flexible part 41. The installation of metal tips in hoses is a technique well known in the prior art and consists essentially of inserting under pressure one end of the hose into a first threaded piece. A second metal piece is then threaded into the first metal piece, further pressing the end of the hose and providing an interface for fitting into another piece. From this moment on, the metal tip can be connected to a rigid part 42 by means of, for example, a screwed flange or threading. Another way of connecting a metal tip to a rigid part 42 is by means of the Tuf-Lok® system manufactured and commercialized by the company Dynamic Air.

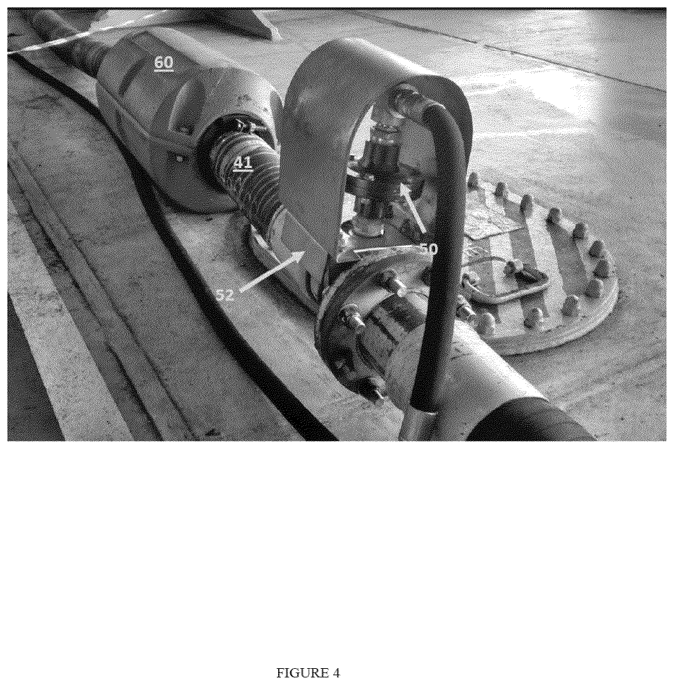

In a preferred embodiment of the present invention, the gas injecting device 50 can be protected by a cover 51. The presence of a cover 51 protects the gas injecting device 50 from possible shocks. This is particularly useful since the conveying line 40 according to the present invention facilitates the pneumatic conveyance of materials in more hostile environments. Preferably, the cover 51 is a metal sheet material folded around the gas injecting device 50. As can be seen in FIG. 4, in an exemplary embodiment, the sheet of metal material is folded and positioned on a base 52. The base 52 can be free or fixed to the rigid part 42 where the gas injecting device 50 is installed.

In another preferred embodiment of the present invention, the conveying line 40 may comprise an elevating element 60. At least one elevating element 60 is positioned around at least one flexible part 41 to elevate a portion of the flexible part 41 where it is installed. The presence of the elevating element 60 is beneficial to reduce possible damage caused by friction of the conveying line 40 with the ground and to maintain alignment in the connection between a flexible part 41 and a rigid part 42. Additionally, in the case of installation of the conveying line in a path that is at least partially aquatic, the elevating element 60 may act as a float, keeping at least part of the line above the water surface.

The elevating element 60 may have any shape capable of elevating a portion of a flexible part 41. Preferably, the elevating element 60 is cylindrical and made of plastic material. Even more preferably, the elevating element 60 comprises two parts, a lower part and an upper part, with a semi-cylindrical internal longitudinal section, which can be joined and bolted around a flexible part 41 (FIG. 4).

In an even more preferred embodiment of the present invention, as can be seen in FIG. 2, an elevating element 60 is positioned around the ends of each flexible part 41, in the vicinity of the connection between each flexible part 41 and each rigid part 42. In addition to reducing friction of the conveying line 40 with the ground and keeping the connections between the rigid parts and the flexible parts aligned, this configuration also elevates the gas injecting devices 50, further protecting it.

1. A conveying line for the pneumatic conveyance of materials, comprising:
at least one flexible part;
at least one rigid part; and
at least one gas injecting device installed in at least one of the rigid parts,
wherein the at least one flexible part and the at least one rigid part are intercalatedly connected.

2. The conveying line of claim 1, wherein the gas is air.

3. The conveying line of claim 1, additionally comprising at least one cover positioned around at least one gas injecting device.

4. The conveying line of claim 1, additionally comprising at least one elevating element positioned around an end of a flexible part.

5. The conveying line of claim 4, wherein the elevating element is a cylindrical element.

6. A conveying line of claim 4, wherein the elevating element is positioned at the ends of each flexible part close to the connection with each rigid part.

7. A use of the conveying line of claim 1 in the pneumatic conveyance of materials.

8. A pneumatic conveyance system, comprising at least one pneumatic conveyor and a conveying line of claim 1.
